(19) United States
(12) Patent Application Publication
(10) Pub. No.: US 2009/0193958 A1
(43) Pub. Date: Aug. 6, 2009

(54) Double Idiophone

(76) Inventor: Jeffrey Allen Webb, San Marcos, CA (US)

Correspondence Address: BUCHE & ASSOCIATES, P.C., 875 PROSPECT, SUITE 305, SUITE 205, LA JOLLA, CA, 92037, US

(21) Appl. No.: 12/027,227

(22) Filed: Feb. 6, 2008

(51) Int. Cl. G10D 13/08

(52) U.S. Cl. 84/406; 84/409

(57) ABSTRACT

An idiophone comprising a first idiophonic member, a second idiophonic member, and, a means for swingably fastening said second idiophonic member within said first idiophonic member; and where the idiophone may take the form of a bell with a tuning fork for a clapper.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The present application relates to the fields of musical instruments, namely, bells. The present application also relates to the field of idiophones wherein sound is primarily produced by the instrument vibrating itself without the use of strings or membranes.

2. Background of the Invention

Typically, a bell is a percussion instrument (sometimes called a concussion idiophone) defined by an open ended, hollow body which resonates sound upon being struck. In many instances, the means for striking is usually a clapper which suspends within the bell's hollow and swings or pivots to contact the bell body at its inner wall. A struck bell body vibrates to emit a single musical tone.

A tuning fork is also an idiophone which resonates at specific pitch or tone when struck. Most often, a tuning fork is defined by two tines which form a U-shaped bar whereby the tuning fork is operated by striking its tines against objects thereby causing the tines to vibrate. Until now, tuning forks have not been used as the clapper of a bell.

Since idiophones, such as bells and tuning forks, emit a single tone or pitch, musical instruments require the striking of more than one at a time to achieve a chord or note combination. Accordingly, musicians hoping to incorporate idiophones into musical compositions are limited by the amount of idiophones a player can strike at any one time. Moreover, if a player desires to play separate types of idiophonic instruments, rows of individual idiophones are required for each individual type. Until now, no musical instrument has incorporated a tuning fork as the clapper of a bell.

### SUMMARY OF THE INVENTION

Accordingly, it is an objective of the present application to provide an improved idiophone, wherein two separate types of idiophones may be played by operating a single musical instrument.

It is yet another object of the present application to provide an idiophone which emits more than a single tone or pitch when operated.

It is a further object of the present application to provide a series of idiophones of varying tone or pitch wherein a musician may strike many idiophones simultaneously.

It is a further object of the present application to incorporate different types of idiophones into a single idiophone.

It is yet a further object of the present application to provide a bell with a tuning fork as a clapper, which is aesthetically pleasing in shape and appearance, as well as operation.

Other objectives of the invention will become apparent to those skilled in the art once the invention has been shown and described. These objectives are not to be construed as limitations of applicant's invention, but are merely aimed to suggest some of the many benefits that may be realized by the apparatus of the present application and with its many embodiments.

### BRIEF DESCRIPTION OF THE DRAWING

The manner in which these objectives and other desirable characteristics can be obtained is explained in the following description and attached drawings in which:

FIG. 1A is the top perspective of a three-dimensional rendering of the double idiophone 1 of the present application.

FIG. 1B is a side view of the double idiophone 1 depicted in FIG. 1A.

FIG. 1C is another side view of the double idiophone 1 depicted in FIG. 1A wherein the view has been rotated by 90° relative to the perspective of FIG. 1B.

FIG. 1D is a top view of the double idiophone depicted in FIGS. 1A through 1C.

FIG. 2A is a bottom perspective of a three-dimensional rendering of a double idiophone 1 of the present application.

FIG. 2B is a bottom view of the double idiophone depicted in FIG. 2A.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF THE INVENTION

The double idiophone 1 of the present application is generally defined by a first idiophonic member 10 and a second idiophonic member 20 which cooperate with each other as a single musical instrument. A musician will typically operate the double idiophone 1 by simultaneously initiating a musical tone or pitch from both the first idiophonic member 10 and the second idiophonic member 20. The more specific elements and features of the double idiophone 1 are more fully described and depicted in the drawings.

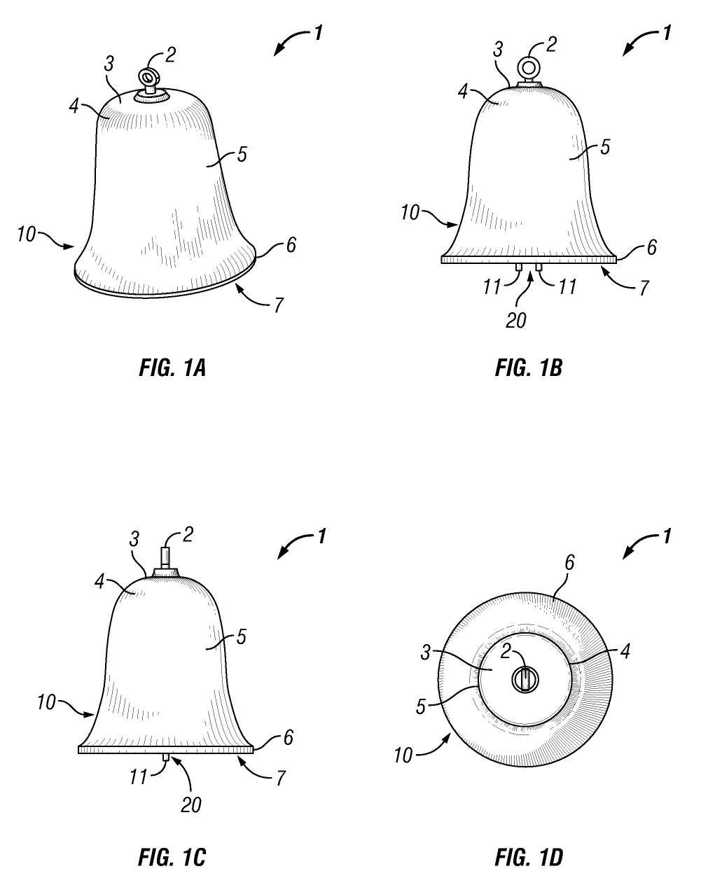

FIG. 1A is a top perspective of a three-dimensional rendering of the double idiophone 1 and illustrates the instrument's outer structure, which is generally defined by the first idiophonic member 10. As illustrated by this figure, the first idiophonic member 10 typically features a hollow, gradually tapering circumferential body 5 defined by: an open mouth 7 surrounded by a flared lip 6 at one end; a head 3 connected to the body via a circumferential shoulder 4 at the other; and, a crown affixed atop the head 3 of the double idiophone 1. In other words, the first idiophonic member 10 is typically a bell. FIG. 1A depicts the crown 2 as a circular ring uprightly fastened to the head 3, which as discussed in further detail below, represents the location from which a musician may manipulate the double idiophone 1. The crown 2 may serve a variety of purposes, but is typically as handle for the user or a securing means for anchoring the bell to a fixture, handle, chain, rope, or any other object. In the present embodiment, the first idiophonic member 10 is a bell.

FIGS. 1B and 1C are side views of the double idiophone 1 which depict the general profile of the first idiophonic member 10. Though similar in appearance, these figures depict different side perspectives which have been rotated by 90° relative to each other. The similarities result from the generally symmetrical and circumferential character of the first idiophonic member 10 around its vertical axis. The profile smoothly, symmetrically, and concavely transitions between the head 3, shoulders 4, and body 5 whereafter the body 5 slowly but symmetrically tapers to the lip 6, at which location the first idiophonic member 10 flares outward. As discussed in further detail below, the first idiophonic member is generally operated by striking it (usually somewhere on the flared lip 6 whereby a fuller amplitude of vibration may be realized) to induce vibrations throughout the first idiophonic member 10 which vibrations resonate sound of a particular tone and pitch. Symmetry and circumferentiality ensure similar and even vibrations, tone, and pitch with every use.

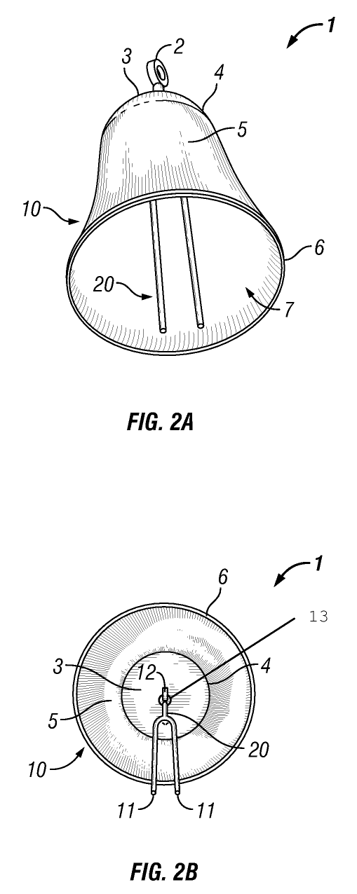

In general, FIGS. 1B and 1C depict the same elements and features illustrated in FIG. 1A, except that the second idiophonic member 20 is seen suspended within the hollow of the first idiophonic member 10 as the clapper of a bell. As discussed below in connection with FIG. 2A, the lower portion of the second idiophonic member is defined by a pair of tines 11, in the form of a U-shaped bar, which, when vibrated, emit an approximately constant pitch and musical tone (i.e., in the present embodiment, the second idiophonic member 20 is a tuning fork). Though the figures depict the second idiophonic member 20 freely suspended within the hollow of the first idiophonic member 10, as discussed in further detail below, the double idiophone 1 is operated by bringing the first idiophonic member 10 into contact with the second idiophonic member 20 (in the same manner a bell is brought into contact with its clapper) whereby vibrations are induced in both. Also discussed below, the symmetry and circumferentiality of the first idiophonic member 10 facilitate use of the instrument because the freely suspended second idiophonic member 20 may be brought into contact with any circumferential point around the first idiophonic member (preferably near to the flared lip 6) to produce a sound. Although FIGS. 1B and 1C show the second idiophonic member 20 protruding from the lower portion of the bell, various sizes of the second idiophonic member 20 are contemplated so that it may or may not extend from the lower portion of the bell.

FIG. 1D is a top view of the double idiophone 1 which further illustrates the symmetrical and circumferential character of the first idiophonic member 10 around its vertical axis. As mentioned above, symmetry and circumferitnaility are important for the musical quality and operability of the first idiophonic member 10. Also depicted in the drawings is the full extent of the flared lip 6. Otherwise, the figure generally depicts the same elements and features illustrated in the other figures. It should be noted, that although the double idiophone 1 serves a musical purpose, the aesthetic appearance of a bell with a tuning fork as a clapper is equally important and beneficial, irrespective of the musical performance of the device.

FIG. 2A is the bottom view of a three dimensional rendering of the double idiophone 1 which generally illustrates the hollow structure of the first idiophonic member 10 and placement of the second idiophonic structure 20 therein. Like the previous figures, FIG. 2A depicts the body 5 with a head 3 and shoulder 4 at one end, and a flared lip 6 and mouth 7 at the other. Unlike the previous figures, FIG. 2A illustrates the open mouth 7 with the second idiophonic member 20 freely suspended within the hollow of the first idiophonic member 10, thereby taking on the position of a clapper in a bell. As illustrated by this figure, the lower portion of the second idiophonic member 20 is, as further illustrated in connection with FIG. 2B, defined in part by a pair of tuning fork tines 11. Those skilled in the arts will appreciate that various sizes and shapes of bells can be used to define the idiophonic member 10, as well as the second idiophonic member 20. While it should be noted that any size of bell or tuning fork is herein contemplated, in one particularly advantageous non-limiting embodiment, the idiophone member 10 has a height in the range of 1 to 2 inches; and the second idiophonic member 20 is approximately 1 inch in length. In yet another non-limiting example, the idiophone member 10 has a height in the range of 4 to 5 inches; and the second idiophonic member 20 is in the range of approximately 2 to 3 inches in length. These examples are by no means intended to act as a limitation on the claims or to delimit the size of the bell and tuning fork mechanisms, including the sizes of the idiophone member 10 and member 20.

FIG. 2B is a bottom view of the double idiophone 1 which illustrates the hollow of the first idiophonic member 10 from the perspective of looking directly into the mouth 7. Due to the tapering body 5 and flared lip 6, the inner wall of the lip 6, body 5, shoulder 4, and head 3 are seen. FIG. 2B depicts the second idiophonic member in a pivoted state, with the tines 11 of the second idiophonic member 20 in contact with the body 5 and/or flared lip 6 of the first idiophonic member 10.

Also, FIG. 2B illustrates the relationship between the first 10 and second 20 idiophonic members. As depicted in the drawing, the double idiophone 1 has a means for freely suspending the second idiophonic member 20, within the hollow of the first idiophonic member 10 (similar to a clapper suspending within a bell). The drawing depicts the suspending means as two chain-linked rings: the first ring 12, also sometimes referred to as a “staple,” is axially fixed to the inner wall of the head 3 within the hollow of the first idiophonic member 10; and, the second ring 13 is positioned at the top of the second idiophonic member 20. The chain-linked rings (12 and 13) allow free suspension of the idiophonic members (10 and 20) when the double idiophone 1 is held upright (as seen in FIGS. 1B, 1C, and 2A) because, the second idiophonic member 20 rotably and/or pivotably hangs the within the hollow of the first idiophonic member 10 along its vertical axis (similar to a clapper suspended within the hollow of a bell). Though chain-linked rings (12 and 13) are depicted in the drawings, other fastening or freely suspending means, including but not limited to such as strings, hooks, loops, ball and socket, clips, cable, bearings, complementary inserting and receiving mechanisms, etc., and are capable of satisfying this function and will be readily apparent to those skilled in the art. Other means may include, but are not limited to, aperture(s) defined in the tuning fork member, which are operationally configured to permit attachment to the bell member. The principal feature of such a means shall be to allow swinging connection of the first and second idiophonic members (10 and 20). Such means may be fashioned from a variety of materials that will be readily apparent to those in the industry, including but not limited to metals, plastics, ceramics, glass, crystal, materials that are molded, extruded, cast, formed, machined, or otherwise fabricated.

FIGS. 1B, 1C, 2A, and 2B illustrate the operation of the double idiophone 1. As mentioned above, the chain-linked rings (12 and 13) allow the second idiophonic member 20 to swingably hang within the hollow of the first idiophonic member 10 (similar to a clapper of a bell), as depicted in FIGS. 1B, 1C, and 2A. In an upright position, there are at least two methods for creating sound: (1) using the crown 2 as a pivot location, the first idiophonic member 10 may be pivoted relative to the free hanging second idiophonic 20 member until the tines 11 of the second idiophonic member 20 contact the body 5 (usually near the flared lip 6) of the first idiophonic member 10 thereby inducing vibrations in both (FIG. 2A position to a FIG. 2B position); and, (2) using the crown 2 as a stationary location, the second idiophonic member 20 may be swung relative to the first idiophonic member 10 until the tines 11 of the second idiophonic member 20 contact the first idiophonic member 10 (usually just above the lip 6) thereby inducing vibrations in both (FIG. 2A position to a FIG. 2B position). In either situation, after the initial contact between the two idiophonic members (10 and 20) the double idiophone may be brought to rest, or the action repeated to produce more sound. In other words, the double idiophone 1 is typically operated as a bell with a tuning fork for a clapper.

The crown 2 is the usual location from which the double idiophone is operated by a musician. As mentioned above, the crown 2 may be a pivot location or a stationary location for the double idiophone 1. Operating the double idiophone 1 from the crown 2 typically allows the user to hold the instrument without dampening the vibrations generated throughout the first 10 and second 20 idiophonic members. If the musician were to grip the double idiophone 1 at the body 5 or lip 7, dampening of vibrations throughout the first idiophonic member 10 would result and sound quality would suffer.

The physical properties of the materials, the physical dimensions, and the specific geometry incorporated in construction of the first 10 and second 20 idiophonic members govern the specific sound tone and pitch emitted by the double idiophone 1. For example, the length of the tines 11 affects the frequency of sound emitted by the second idiophonic member 20. Different variations in the aforementioned variables produce different sounds or notes. Accordingly, a series of double idiophones 1 of varying sizes, materials, or geometry may be used to create an array of musical notes from which a musical work may be composed by operating the individual double idiophones 1 separately or simultaneously. The specific geometry, material, and physical dimensions of the first 10 and second 20 idiophonic members which result in a particular note or pitch will be readily apparent to one skilled in the art. Subject thereto, appropriate materials may include, but are not limited to, metals, ceramics, glass, crystals, plastics, and the like, as are typically used in the construction of bells or tuning forks. Some other metals, specifically, that may be used typically, but are not exclusive, include steel, aluminum, magnesium, titanium, iron, brass, platinum, vanadium, lead, bronze, chromium, pewter, copper, cadmium, cobalt, gold, tin, silver, zirconium, any other element in the periodic chart, and alloys derived therefrom. Moreover, it should be noted that the tuning forks (second idiophonic member 20) and bells (first idiophonic member 10) may be interchangeable with one another or part of a system. In other words, the tuning forks may be removable and interchangeable into different bells to suit user preferences.

In alternate embodiments, the second idiophonic member may be removable whereby various first idiophonic members 10 and second idiophonic members may be “mixed-and-matched” according to the musicians preference or needs. For example, a first idiophonic member 10 may be initially matched with a second idiophonic member 20 that resonates at a particular tone, whereafter the second idiophonic member 20 may be replaced with one having a different tone.

In summary, the invention is an idiophone comprising a first idiophonic member 10 (generally a bell), a second idiophonic member 20 (generally a tuning fork), and a means for bringing said first idiophonic member into contact with said second idiophonic member to vibrate both of said first 10 and second 20 idiophonic members.

It should be noted, that the above specification describes only typical embodiments of this invention and is therefore not to be considered limiting of its scope, for the invention may admit to other equally effective embodiments and components that will be appreciated by those reasonably skilled in the relevant arts. It should also noted that within the specification, the terms “and” and “or” or “and/or” are sometimes used interchangeably and shall encompass the meaning of the other.

1. An idiophone comprising:
a first idiophonic member;
a second idiophonic member; and,
a means for swingably fastening said second idiophonic member within said first idiophonic member.

2. the idiophone of claim 1, further comprising:
a means for pivotably fastening said second idiophonic member within said first idiophonic member.

3. The idiophone of claim 2, wherein said first idiophonic member is hollow.

4. The idiophone of claim 1 wherein said first and second idiophonic members independently vibrate to produce musical tones during use.

5. the idiophone of claim 3, wherein said first idiophonic member is defined by a symmetrical and circumferential body, and wherein said body features a lip and open mouth at one end, and a head at the other end.

6. The idiophone of claim 2, wherein said first idiophonic member is a bell.

7. The idiophone of claim 2 wherein said second idiophonic member is a tuning fork.

8. The idiophone of claim 2 wherein said first idiophonic member is a bell, and said second idiophonic member is a tuning fork.

9. The idiophone of claim 8 wherein said means for pivotably fastening said second idiophonic member within said first idiophonic member is a pair of chain-linked rings.

10. The idiophone of claim 1 wherein said second idiophonic member is removable and replaceable.

11. A system of idiophones comprising:
A plurality of idiophones of varying sound properties, wherein each of said idiophones comprise a first idiophonic member; a second idiophonic member; and, a means for bringing said first idiophonic member into contact with said second idiophonic member to vibrate both of said first and second idiophonic members.

12. The system of idiophones of claim 11 wherein each of said idiophones further comprise a means for swingably fastening said second idiophonic member within said first idiophonic member.

13. The system of idiophones of claim 12 wherein each of said idiophones further comprises a means for pivotably fastening said second idiophonic member within said first idiophonic member.

14. The system of idiophones of claim 12 wherein each of said first idiophonic members is hollow.

15. The system of idiophones of claim 12 wherein each of said first idiophonic members is defined by a symmetrical and circumferential body, and wherein said body features a lip and open mouth at one end, and a head at the other end.

16. The system of idiophones of claim 12 wherein each of said first idiophonic members is a bell.

17. The system of idiophones of claim 12 wherein each of said second idiophonic members is a tuning fork.

18. The idiophone of claim 2 wherein said first idiophonic member is a bell, and said second idiophonic member is a tuning fork.

19. An idiophone comprising
a bell; and,
a clapper, wherein said clapper is a tuning fork.
